(19) United States
(12) Patent Application Publication
(10) Pub. No.: US 2025/0163751 A1
(43) Pub. Date: May 22, 2025

(54) REINFORCEMENT APPARATUS FOR A WINDOW FRAME

(71) Applicant: ZHEN LIU, Winnipeg (CA)

(72) Inventor: ZHEN LIU, Winnipeg (CA)

(21) Appl. No.: 18/953,227

(22) Filed: Nov. 20, 2024

(30) Foreign Application Priority Data
Nov. 21, 2023 (CA) 3220516

(51) Int. Cl. E06B 3/22

(52) U.S. Cl. CPC E06B 3/222

(57) ABSTRACT

A reinforcement apparatus mounts onto one or more extruded plastic window frame members of a window frame. The apparatus includes a reinforcement frame member comprising an extruded profile having a hollow interior and being formed of a fibre composite material. The composite reinforcement frame member is shaped to mate externally alongside the hollow profile of the respective window frame members to both extend the jamb and stiffen the plastic window frame member. In this manner, lower cost plastic window frames can be reinforced subsequent to the assembly of a window frame in a cost-effective manner.

This application claims foreign priority benefits from Canadian Patent Application 3,220,516, filed Nov. 21, 2023.

### FIELD OF THE INVENTION

The present invention relates to a reinforcement apparatus for mounting onto a window frame, for example by being mounted alongside one or more frame members of the window frame.

### BACKGROUND

A common construction of a window frame involves the manufacture of extruded frame members which form a hollow profile that can be cut and sized to mount about the perimeter of a window frame. In some instances, window box frames assembled in this manner can be further mounted adjacent one another in a common plane to define an overall combination window. When the overall window frame spans a large distance in width or height, the frame members may have insufficient strength to adequately resist bending forces from loads perpendicular to a plane of the window frame when the frame members are formed of plastic material. While it is known fibreglass composite materials or metal may be used in place of plastic frame members, these materials result in very high costs.

Canadian Patent Application No. 2,144,550, filed on Mar. 14, 1995 by Topham et al, describes a method of stiffening an extruded frame member by inserting a metal stiffening member within the hollow interior of the frame member. The stiffening member thus requires insertion during the manufacturing stage and cannot be optionally added to an already assembled window frame. Furthermore, in a combination window, the stiffening member cannot pass through the mitre joints at the corners of adjacent box frames without an additional manufacturing step to provide an adequate internal passage for the metal stiffening member. The metal stiffening member can also be costly to manufacture, while typically contributing negatively to the insulative characteristics of the window frame assembly as a whole.

### SUMMARY OF THE INVENTION

According to one aspect of the invention there is provided a reinforcement apparatus for a window frame comprising a plurality of window frame members, each window frame member comprising an extruded profile having a hollow interior and being formed of a plastic material, the apparatus comprising:
a reinforcement frame member comprising an extruded profile having a hollow interior and being formed of a fibre composite material;
the hollow profile of the reinforcement frame member being shaped to mate with the hollow profile of a respective one of the window frame members whereby the reinforcement frame member is arranged to be mounted alongside the respective window frame member externally of the hollow profile of the window frame member.

According to a second aspect of the present invention there is provided a window frame comprising:
a plurality of window frame members, each window frame member comprising an extruded profile having a hollow interior and being formed of a plastic material; and
a reinforcement apparatus including at least one reinforcement frame member mounted alongside a respective one of the window frame members externally of the hollow profile of the window frame member;
wherein the at least one reinforcement frame member comprises an extruded profile having a hollow interior in which the extruded profile is shaped to mate with the hollow profile of said respective one of the window frame members; and
wherein said at least one reinforcement frame member is formed of a fibre composite material.

By mounting composite reinforcement frame members externally on the hollow profile of corresponding window frame members in a window frame, lower cost plastic window frames can be reinforced subsequent to the assembly of box frames into an assembled window frame in a cost-effective manner. Furthermore, forming the reinforcement member of composite material allows the composite reinforcement frame member to be similar in appearance to the window frame to further function as a suitable jamb extension to provide the reinforcement frame member with dual functionality of a jamb extension and a stiffener.

Another benefit of the reinforcement frame member formed of composite material is that the fiberglass material is inherently designed to maintain, if not enhance, the thermal insulation efficacy of the window frame assembly. This is in stark contrast to conventional metal reinforcements, which have a propensity to diminish such insulative characteristics. Furthermore, the augmented depth of the window frame, attributed to the integration of the fiberglass reinforcement extension, ostensibly contributes to an elevated insulative performance of the entire window system.

The hollow profile of the reinforcement member may be arranged to be interlocked with the hollow profile of the window frame member so as to retain the reinforcement member mounted on the window frame member.

The hollow profile of the window frame member may include a channel formed externally thereon, in which the hollow profile of the reinforcement frame member includes a protrusion formed externally thereon such that the protrusion forms a mating connection with the channel to retain the reinforcement frame member mounted on the window frame member. The protrusion may further include a catch formed thereon and arranged to be releasably retained on a corresponding catch within the channel of the window frame member. The protrusion may further include a cam surface acting to resiliently deflect the protrusion so as to enable the catch on the protrusion to be displaced past the catch on the channel of the window frame member as the protrusion in inserted into the channel in a mounting direction oriented perpendicularly to a plane of the window frame.

The reinforcement frame member may be arranged to be mounted along a perimeter of the window frame to protrude from the window frame perpendicularly to a plane of window frame so as to define an interior jamb extension of the window frame. In this instance, an interior surface of the reinforcement frame member that is oriented perpendicularly to the plane of the window frame is preferably arranged to lie flush with a corresponding interior surface of the window frame member upon which the reinforcement frame member is supported.

The reinforcement frame member may further be arranged to be mounted along an intermediate frame member among the window frame members in which the intermediate frame member is located at an intermediate location spaced from other window frame members that are parallel to the intermediate frame member and at a perimeter of the window frame. Preferably a width of the reinforcement frame member has a width parallel to the plane of the window frame that is substantially equal to a width of the intermediate frame member upon which the reinforcement frame member is supported.

The reinforcement frame member may be used an identical frame member that is identical to the reinforcement frame member. When the window frame comprises a combination window of two or more window box frames mounted adjacent to one another and the intermediate frame member is formed by two adjacent box frame members of the box frames that extend alongside one another, the reinforcement frame member is preferably mounted to extend alongside the identical frame member. In this instance, the reinforcement frame member and the adjacent frame member are arranged to be mounted onto respective ones of the two adjacent box frame members.

When the box frame members of the intermediate frame member each include a channel formed externally thereon, the reinforcement frame member and the identical frame member preferably each include a protrusion formed externally thereon in which the protrusions form a mating connection with the channels to retain the reinforcement frame member and the identical frame mounted on the window frame. In this instance, the reinforcement frame member and the identical frame member may each include a channel formed therein along an opposing boundary from the protrusion in which the channels on the reinforcement frame member and the identical frame member are substantially identical to the channels on the box frame members.

When the window frame comprises a combination window of window box frames mounted adjacent one another such that the combination window has a width corresponding to two or more of the window box frames mounted adjacent to one another in a lateral direction and a height corresponding to two or more of the window box frames mounted adjacent to one another in a vertical direction, preferably the reinforcement frame member is arranged to be mounted alongside box frame members of the window box frames so as to span an overall length corresponding to said width or said height of the combination window. Preferably the reinforcement frame member spans across the window frame along a shortest one of said width and said height.

### BRIEF DESCRIPTION OF THE DRAWINGS

Some embodiments of the invention will now be described in conjunction with the accompanying drawings in which:

FIG. 1 is a schematic representation of a combination window frame assembled from a plurality of individual box frames and including a reinforcement apparatus according to the present invention supported thereon;

FIG. 2 is a partly sectional perspective view of an intersection of four box frames within the combination window frame according to a first embodiment of the reinforcement apparatus;

FIG. 3 is a sectional view along the line 3-3 in FIG. 1 according to the first embodiment of FIG. 2;

FIG. 4 is a sectional view along the line 3-3 in FIG. 1 according to the first embodiment of FIG. 2;

FIG. 5 is a sectional view along the line 3-3 in FIG. 1 according to the first embodiment of FIG. 2;

FIG. 6 is a partly sectional perspective view of an intersection of four box frames within the combination window frame according to a second embodiment of the reinforcement apparatus;

FIG. 7 is a sectional view along the line 3-3 in FIG. 1 according to the second embodiment of FIG. 6;

FIG. 8 is a sectional view along the line 3-3 in FIG. 1 according to the second embodiment of FIG. 6; and

FIG. 9 is a sectional view along the line 3-3 in FIG. 1 according to the second embodiment of FIG. 6.

In the drawings like characters of reference indicate corresponding parts in the different figures.

### DETAILED DESCRIPTION

Referring to the accompanying figures there is illustrated a window reinforcement apparatus generally indicated by reference numeral 10. The apparatus 10 is suited for use with a window frame 12 of the type assembled from a plurality of extruded, hollow, profiles defining respective window frame members 14 of the window frame.

In the illustrated embodiment, the window frame 12 is a combination window assembled from a plurality of individual box frames 16, in which each box frame is assembled from a set of window frame members 14 that extend end-to-end about the full perimeter of a central window opening of the box frame. In the instance of a rectangular box frame according to the illustrated embodiment, four window frame members 14 are supported to extend along the four sides of the rectangular shape while being joined to one another at 45 degree mitered corners.

The central window opening 18 of each box frame can receive (i) a fixed mounted glass assembly 20 supported therein or (ii) an operator window sash 22 that supports a window glass assembly 20 therein while being supported relative to the box frame to be opened and closed relative to the window opening. In each instance, the glass assembly 20 comprises a plurality of panes of glass mounted parallel and spaced apart from one another by a perimeter insulating member to maintain a gap between the panes while joining the edges of the panes to one another in a sealed assembly.

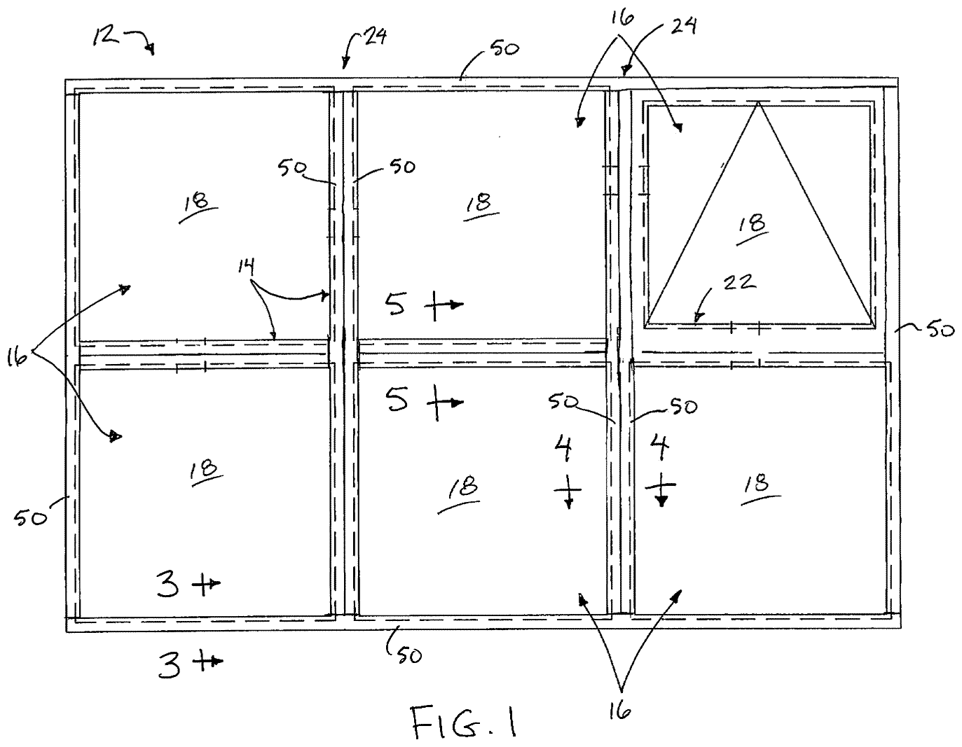

The box frames 16 are assembled in a matrix or grid pattern such that the box frames lie in a generally common plane. In the illustrated embodiment, the box frames are stacked in columns that are two box frames high while the columns are mounted adjacent to one another to form two rows of box frames that are three box frames wide. Any other arrangement of box frames can be similarly assembled in a common frame to collectively define an assembled combination window similarly to the window frame shown in FIG. 1.

In the resulting assembled combination window, some of the window frame members 14 of the box frames are positioned at the perimeter of the overall combination window frame. In this instance, individual window frame members 14 of the box frames define the full thickness of the perimeter frame about the perimeter.

Some of the frame members 14 of the box frame 16 however are situated at intermediate locations spaced inwardly from the perimeter frame members where two box frames are abutted adjacent to one another. At the intermediate locations, the window frame members 14 of two adjacent box frames extend alongside one another to collectively define an intermediate frame member. In the assembled window frame, the intermediate frame members are parallel to respective portions of the perimeter at a location spaced inwardly from the respective portions of the perimeter, while collectively spanning across the full width or height of the assembled window frame corresponding to the width or height of a plurality of box frames mounted adjacent to one another. Each intermediate frame member 24 spanning across the corresponding dimension of the assembled window thus also includes window frame members 14 of adjacent box frames that are connected end-to-end with one another in addition to being alongside one another.

Each window frame member 14 is a hollow plastic profile that is extruded from plastic material, for example PVC so as to be continuous in cross-sectional shape along the length of the frame member. The resulting cross-sectional shape includes an inner side 30 and an outer side 32 which are generally parallel to one another and perpendicular to a plane of the window. The inner side 30 and the outer side 32 are primarily flat and define an overall width of the frame member within the plane of the window, perpendicular to the length of the frame member.

Each window frame member 14 also includes a depth defined perpendicularly to the plane of the window frame so as to extend between an exterior end 34 to be mounted to the exterior or outside of the building and an interior end 36 to be mounted to the interior or inside of the building upon which the window is mounted. The interior end 36 and the exterior end 34 are situated at opposing boundaries of the profile shape of the window frame members. When mounted at the perimeter of a window frame 12, the outer side 32 of the profile corresponds to the outer perimeter boundary of the assembled window frame, whereas the inner side 30 serves to support the glass assembly 20 of the window thereon.

When mounted at an intermediate location of the assembled window frame, the outer side 32 of the profile is abutted against the corresponding outer side of the profile of an adjacent box frame such that the inner sides 30 of the adjacent frame members serve to support respective glass assemblies 20 of two adjacent window box frames. The inner sides 30 of the profiles that collectively form an intermediate frame member, are a situated at opposite lateral boundaries of the overall intermediate frame member and serve to define the overall lateral width of the intermediate frame member between the two inner sides 30.

The cross-sectional shape of the profile further includes a glass channel 38 recessed into the inner side 30 to receive a mounting trim 40 interlocked therein. The mounting trim 48 together with the remaining boundary shape at the inner side 30 of each window frame member forms a perimeter channel about the interior perimeter of the box frame that receives a corresponding perimeter edge of a glass assembly 20 recessed therein in the mounted configuration of the glass assembly on the box frame.

At the exterior end 34 of each frame member 14, the profile includes an exterior trim channel 42 recessed therein into which an exterior trim profile 44 can be mounted which forms an exterior moulding about the perimeter of the assembled window frame at the exterior of the building. When the frame members 14 are mounted at an intermediate location in the assembled window frame, a coupling trim member 46 is provided for mounting into the exterior trim channels 42 of two adjacent window frame members 14 that collectively form one of the intermediate frame members of the assembled window frame.

At the interior end 36 of each frame member, the profile includes an interior jamb channel 48 suitable for mounting a window jamb therein. The interior jamb channel 48 is identical in configuration to the exterior trim channel 42 so as to comprise a recessed groove that is recessed into the interior of the profile while defining an inner catch internally therein.

The reinforcement apparatus 10 according to the present invention comprises one or more reinforcement frame members 50 arrange to be mounted into the interior jamb channels 48 of one or more frame members 14 of the assembled window frame 12. Each reinforcement frame member 50 is an extruded hollow profile that has a continuous cross-sectional shape along the length thereof. The reinforcement frame members are extruded of a composite material, for example fiberglass. Although various embodiments of the reinforcement frame members 50 are illustrated in the accompanying figures, the features in common with the various embodiments will first be described.

Similarly to the window frame members 14, each reinforcement frame member includes an inner side 52 and an outer side 54 which are parallel to one another at laterally opposing boundaries that are generally perpendicular to the plane of the window. The distance between the inner side 52 and the outer side 54 of each reinforcement frame member 50 thus defines the lateral width of the frame member, in a direction parallel to the plane of the window. Width in the lateral direction of each reinforcement frame member 50 is approximately equal to the width of a corresponding box frame member 14 between the inner side 30 and outer side 32 thereof so as to be suitable for functioning as a jamb extension when the reinforcement frame member 50 is mounted onto a respective one of the frame members 14.

Each reinforcement frame member 50 has a longitudinal depth measured perpendicularly to the plane of the window between an exterior end 56 towards the exterior of the building and an interior end 58 towards the interior of the building such that the inner end 58 and the exterior and 56 form opposing boundaries of the extruded shape. The reinforcement frame member 50 is shaped so that the cross-sectional shape of the profile is elongated in depth between the interior end and exterior end relative to the lateral width between the inner side 52 and the outer side 54.

The extruded profile shape of each reinforcement frame member is arranged such that the inner side 52 is flat, smooth, continuous and uninterrupted between the interior end 58 and the exterior end 56. The outer side includes channels or grooves formed therein for strength, but otherwise remains generally flat. When mounted at a perimeter location of the assembled window frame, the flat outer sides 54 of the reinforcement frame members 50 are abutted or situated closely alongside corresponding wall framing members of the building. When mounted at an intermediate location within the assembled window frame, to reinforcement frame members 50 are mounted with their outer sides 54 abutted against one another so that an overall combined width of the two reinforcement frame members 50 is defined as the distance between the laterally opposed inner sides 52.

The exterior end 56 of each reinforcement frame member 50 includes a protrusion 60 formed thereon in which the protrusion functions as a hook having a catch 62 on the hook which can be retained on a corresponding catch within the interior jamb channel 48 of a corresponding window frame member upon which the reinforcement frame member 50 is mounted. The material forming the reinforcement frame member 50 is somewhat resilient such that a sloped cam surface at the leading end of the protrusion 60 can engage a protruding catch within the groove of the interior jamb channel 48 to sufficiently deflect the catch 62 of the protrusion around the catch within the interior jamb channel 48 when the protrusion 60 is inserted into the interior jamb channel 48 perpendicularly to the plane of the window. The protrusion 60 thus mates closely within the interior jamb channel 48 of a window frame member 14 in a snap-fit arrangement that allows the catch 62 on the protrusion to be deflected around and subsequently retained on a corresponding catch within the interior jamb channel 48 and thereby retain the reinforcement frame member 50 mounted relative to the corresponding window frame member 14.

At the interior end 58 of each reinforcement frame member 50, a mounting channel 64 is provided in the form of a recessed groove which is substantially identical in configuration to the recessed groove forming the interior jamb channel 48 of the window frame member 14 upon which the reinforcement frame member 50 is mounted.

When mounted at a perimeter location on the assembled window frame, the mounting channel 64 at the interior end of each reinforcement frame member 50 is concealed by interior window trim.

When mounted at an intermediate location in the assembled window frame onto one of the intermediate frame members, one of the reinforcement frame members 50 is mounted onto each of the adjacent box frame members 14 of two adjacent box frames forming the intermediate frame member.

In this instance, at the interior end of the reinforcement frame members 50, the mounting channels 64 of the adjacent reinforcement frame members 50 are positioned adjacent to one another to receive a coupling trim 66 similar to the coupling trim 46 at the exterior of the window. Both the coupling trim 46 and the coupling trim 48 comprises an elongate member which is generally U-shaped in cross-section so as to define a central bridge portion 68 and two protrusions or legs 70 extending perpendicularly from the bridge portion 68 at opposing edges of the bridge portion. Each of the protrusions or legs 70 comprises a hook with a corresponding catch thereon so as to be substantially identical to the protrusions 60 at the exterior end 56 of each reinforcement frame member 50. The bridge portion 68 has a suitable dimension such that the protrusions 70 align with the mounting channels 64 of two adjacent reinforcement frame members 50 at the intermediate locations of the window frame. The bridge portion 68 thus serves to span across the seam between the pair of reinforcement frame members 50 that extend alongside one another. The grooves forming the mounting channels 64 are sufficiently recessed into the profile of the reinforcement frame member that the bridge portion 68 is mounted substantially flush with the remaining boundary at the interior end 58 of the reinforcement frame members 50. The coupling trim 66 includes catches for being retained on corresponding catches within the mounting channel 64 so as to be mounted in place with a snap fit arrangement by inserting the protrusions perpendicularly to the plane of the window frame into the mounting channels during assembly for concealing the seam. The coupling trim 66 spans a full dimension of the assembled window frame corresponding to the full height or full width so as to span the length of multiple box frames according to the illustrated embodiment.

In use, each reinforcement frame member 50 is mounted either along the perimeter or at an intermediate frame member of the assembled window frame so as to span the full height or full width of the window frame corresponding to the combined height or combined width of multiple box frames assembled adjacent to one another to form the combination window frame. In the instance of a combination window frame that is multiple box frames high and multiple box frames wide, the reinforcement frame members 50 at interior locations within the window are mounted to span across the full dimension of the assembled window frame that corresponds to the shortest one of the width or the height.

In the example of FIG. 1, the reinforcement frame members 50 mounted at intermediate locations across the interior of the assembled window frame are thus mounted to span vertically the full height of the window frame at the locations of laterally adjacent box frames. At each intermediate location, two reinforcement frame members 50 extend alongside one another across the full height to span the height of two box frames with each reinforcement frame member 50 being coupled by the protrusion thereof inserted into the mounting channels of box frame members 14 of different box frames.

According to the present invention, the combination window frame is initially manufactured by cutting window frame members 14 to the desired length to be mounted about the perimeter of each box frame 16 so that the box frames can be individually assembled. The box frames are then mounted to one another to form the assembled combination window frame as shown in FIG. 1. After assembly of the box frames into a combination window frame, the reinforcement frame members 50 are then mounted about the full perimeter of the combination window and across the full height of the combination window at the designated intermediate locations corresponding to the junction of laterally adjacent box frames.

Alternatively, when the window is taller than it is wide, the reinforcement frame members 50 at interior locations are instead mounted laterally across the full width of the assembled combination window frame.

In each instance, the reinforcement frame members 50 are mounted by inserting the protrusions of the reinforcement frame members 50 into corresponding interior jamb channels 48 of the window frame members 14 in a direction that is perpendicular to the plane of the window. The catches on the protrusions 60 can be retained on corresponding catches within the interior jamb channels 48 to retain the reinforcement frame members 50 mounted on the window frame.

Alternatively, adhesive compounds including caulking and the like can be placed within the interior jamb channel 48 prior to mounting the protrusions of the reinforcement frame members therein to adhesively retain the reinforcement frame members 50 mounted relative to the window frame members in addition to or instead of the mechanical connection of the catches described above.

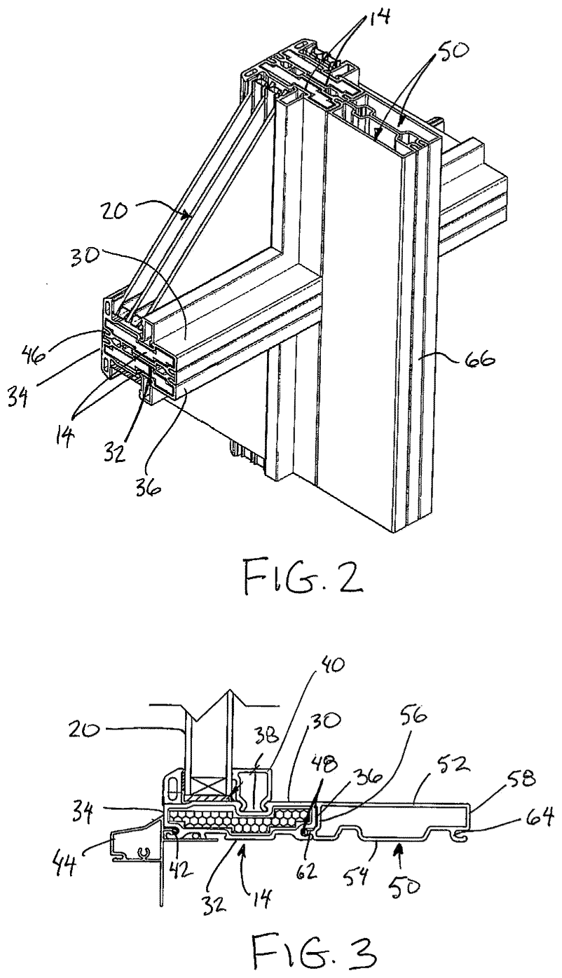

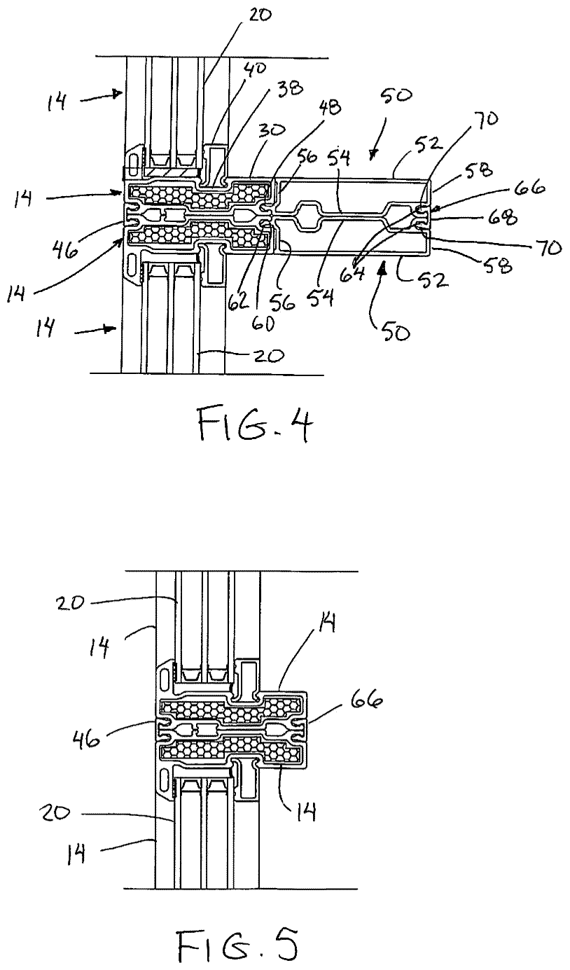

Turning now to FIGS. 1 through 5, according to a first embodiment of the reinforcement frame members 50, the cross-sectional shape of the reinforcement frame members defines an overall depth between the exterior end 56 and the interior end 58 which is near to the overall depth of the window frame members 14 upon which the reinforcement frame members are mounted.

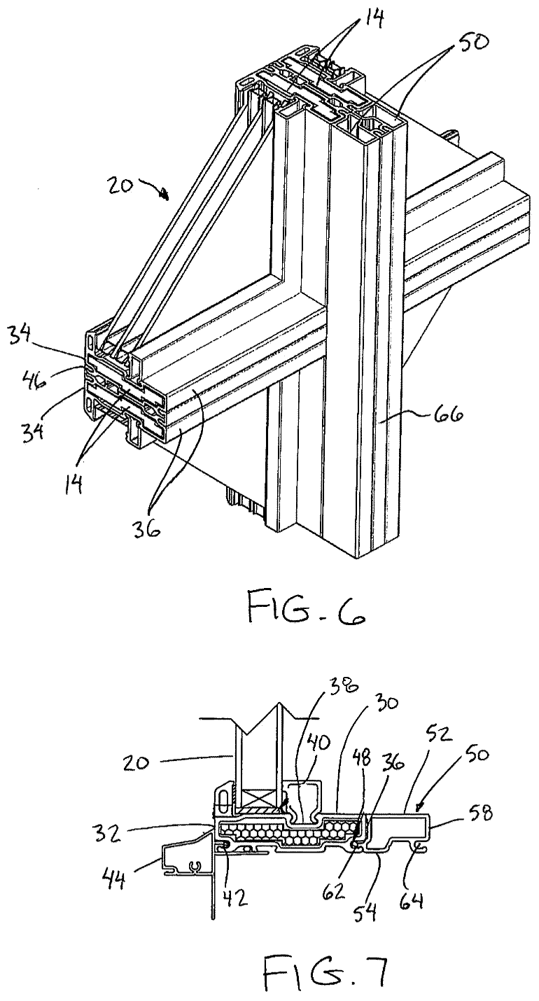

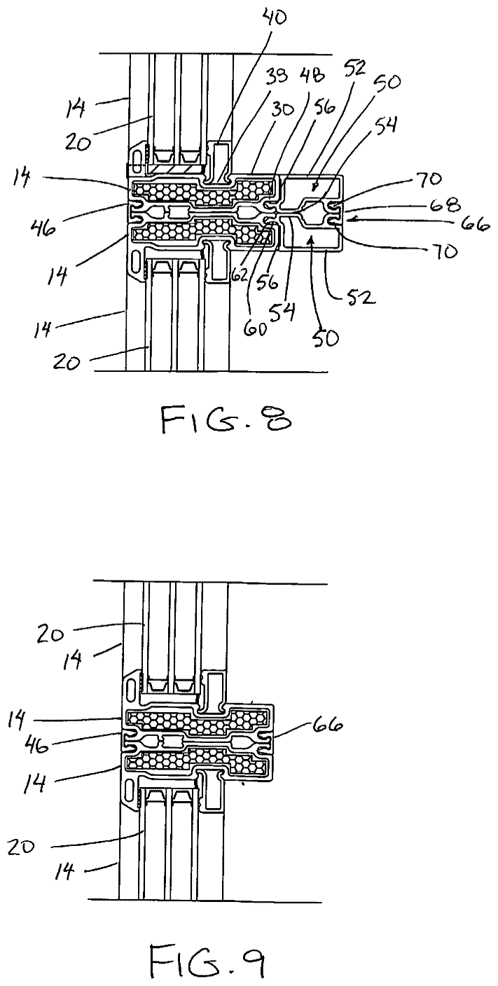

With reference to FIGS. 6 through 9, according to a second embodiment of the reinforcement frame members 50, the cross-sectional shape of the reinforcement frame members is substantially identical to the previous embodiment the exception of the depth being much shorter, in the order of half the depth of the first embodiment as measured perpendicularly to the plane of the window between the exterior end 56 and the interior end 58.

In yet further embodiments, the reinforcement frame members 50 may be varied in depth to accommodate different thicknesses of walls upon which the window frame is mounted.

Since various modifications can be made in my invention as herein above described, and many apparently widely different embodiments of same made, it is intended that all matter contained in the accompanying specification shall be interpreted as illustrative only and not in a limiting sense.

1. A reinforcement apparatus for a window frame comprising a plurality of window frame members, each window frame member comprising an extruded profile having a hollow interior and being formed of a plastic material, the apparatus comprising:
a reinforcement frame member comprising an extruded profile having a hollow interior and being formed of a fibre composite material;
the hollow profile of the reinforcement frame member being shaped to mate with the hollow profile of a respective one of the window frame members whereby the reinforcement frame member is arranged to be mounted alongside the respective window frame member externally of the hollow profile of the window frame member.

2. The apparatus according to claim 1 wherein the hollow profile of the reinforcement member is arranged to be interlocked with the hollow profile of the window frame member so as to retain the reinforcement member mounted on the window frame member.

3. The apparatus according to claim 1 wherein the hollow profile of the window frame member includes a channel formed externally thereon and wherein the hollow profile of the reinforcement frame member includes a protrusion formed externally thereon, the protrusion forming a mating connection with the channel to retain the reinforcement frame member mounted on the window frame member.

4. The apparatus according to claim 3 wherein the protrusion includes a catch formed thereon and arranged to be releasably retained on a corresponding catch within the channel of the window frame member.

5. The apparatus according to claim 4 wherein the protrusion includes a cam surface acting to resiliently deflect the protrusion so as to enable the catch on the protrusion to be displaced past the catch on the channel of the window frame member as the protrusion in inserted into the channel in a mounting direction oriented perpendicularly to a plane of the window frame.

6. The apparatus according to claim 1 wherein the reinforcement frame member is arranged to be mounted along a perimeter of the window frame to protrude from the window frame perpendicularly to a plane of window frame so as to define an interior jamb extension of the window frame.

7. The apparatus according to claim 6 wherein an interior surface of the reinforcement frame member that is oriented perpendicularly to the plane of the window frame is arranged to lie flush with a corresponding interior surface of the window frame member upon which the reinforcement frame member is supported.

8. The apparatus according to claim 1 wherein the reinforcement frame member is arranged to be mounted along an intermediate frame member among the window frame members, the intermediate frame member being located at an intermediate location spaced from other window frame members that are parallel to the intermediate frame member and at a perimeter of the window frame.

9. The apparatus according to claim 8 wherein a width of the reinforcement frame member has a width parallel to the plane of the window frame that is substantially equal to a width of the intermediate frame member upon which the reinforcement frame member is supported.

10. The apparatus according to claim 8 further comprising an identical frame member that is identical to the reinforcement frame member, wherein:
the window frame comprises a combination window of two or more window box frames mounted adjacent to one another,
the intermediate frame member is formed by two adjacent box frame members of the box frames that extend alongside one another,
the reinforcement frame member is mounted to extend alongside the identical frame member, and
the reinforcement frame member and the adjacent frame member are arranged to be mounted onto respective ones of the two adjacent box frame members.

11. The apparatus according to claim 10 wherein the box frame members of the intermediate frame member each include a channel formed externally thereon, and wherein the reinforcement frame member and the identical frame member each include a protrusion formed externally thereon, the protrusions forming a mating connection with the channels to retain the reinforcement frame member and the identical frame mounted on the window frame.

12. The apparatus according to claim 11 wherein the reinforcement frame member and the identical frame member each include a channel formed therein along an opposing boundary from the protrusion, the channels on the reinforcement frame member and the identical frame member being substantially identical to the channels on the box frame members.

13. The apparatus according to claim 1 wherein the window frame comprises a combination window of window box frames mounted adjacent one another such that the combination window has a width corresponding to two or more of the window box frames mounted adjacent to one another in a lateral direction and a height corresponding to two or more of the window box frames mounted adjacent to one another in a vertical direction, and wherein the reinforcement frame member is arranged to be mounted alongside box frame members of the window box frames so as to span an overall length corresponding to said width or said height of the combination window.

14. The apparatus according to claim 1 wherein the reinforcement frame member spans across the window frame along a shortest one of said width and said height.

15. A window frame comprising:
a plurality of window frame members, each window frame member comprising an extruded profile having a hollow interior and being formed of a plastic material; and
a reinforcement apparatus including at least one reinforcement frame member mounted alongside a respective one of the window frame members externally of the hollow profile of the window frame member;
wherein the at least one reinforcement frame member comprises an extruded profile having a hollow interior in which the extruded profile is shaped to mate with the hollow profile of said respective one of the window frame members; and
wherein said at least one reinforcement frame member is formed of a fibre composite material.
